(19) United States
(12) Patent Application Publication
(10) Pub. No.: US 2018/0361650 A1
(43) Pub. Date: Dec. 20, 2018

(54) TRANSPARANT DRAWN ARTICLE

(71) Applicant: DSM IP Assets B.V., Heerlen (NL)

(72) Inventors: Lihua SHEN, Echt (NL); John Richard SEVERN, Echt (NL); Cornelis Wilhelmus Maria BASTIAANSEN, Echt (NL)

(21) Appl. No.: 16/061,820

(22) PCT Filed: Dec. 16, 2016
(86) PCT No.: PCT/EP2016/081365

§ 371 Date: Jun. 13, 2018

(30) Foreign Application Priority Data
Dec. 16, 2015 (EP) 15200365.3

(51) Int. Cl. B29C 55/02; B29C 55/04; B29C 55/00; D01F 1/10; D01F 6/04; D01F 6/60

(52) U.S. Cl. CPC B29C 55/023; B29C 55/04; B29C 55/005; C08J 5/18; D01F 6/04; D01F 6/60; D01F 1/10

(57) ABSTRACT

The invention relates to a stretched molded article comprising a polymer A and a compound B, wherein the polymer A is a polyamide or a polyolefin and is at least partially oriented and comprises a crystalline phase and a non-crystalline phase, wherein the mass of compound B is from 0.25 to 10 mass % relative to the mass of polymer A, and wherein the compound B has a refractive index (n_{B}) higher than the isotropic refractive index of polymer A (n_{A}). The invention further relates to a process for manufacturing such stretch molded article, the use of such stretch molded articles and a product comprising such stretch molded article.

The invention relates to transparent stretch molded articles comprising at least partially oriented polymer, wherein the polymer is a polyamide or a polyolefin and to a method to produce such transparent molded articles.

Stretched molded articles comprising at least partially oriented polymers comprising a crystalline phase and a non-crystalline phase are well known products in the industry, very often they come in the form of fibres, tapes or films. Typically such products can be obtained by drawing in the solid state of both melt- and solution-crystallized polymers, resulting in a high degree of molecular orientation and chain-extension. Often the oriented polymer articles exhibit high modulus and high strength, especially when measured in the direction of polymer orientation such as for example presented in WO2007/122010 and WO2013/087827. It was observed by the inventors that the optical transmittance, often also referred to as transparency, in the wavelength range between 400 and 800 nm of oriented polymer articles is usually rather low, both before and/or after a solid state drawing, which limits their usefulness in certain applications.

According to the inventors knowledge, only a few studies describe the preparation solid state drawn polymers aiming to improve optically transmittance. In Jarecki et al, Polymer (Guildf). 1979, 20, 1078, transparent ultra-drawn HDPE samples could be obtained by processing a low molecular weight polymer with a broad molecular weight distribution at high temperatures. Such method cannot be applied broadly to other polymers and manufacturing processes and hence transparent oriented polymer articles, especially transparent throughout the whole visible spectrum, are not readily available.

A further well known technique to improve transmittance of polymer articles is the use of nucleating agents. Such agents interfere with the polymer crystallization process and results in an increased transmittance of the obtained articles. Nevertheless it has been observed that nucleating agent cannot be applied broadly, especially where the production process involves a solid state drawing step which results in articles with oriented polymers.

It is hence the objective of the present invention to provide articles comprising at least partially oriented polymers with improved visible light transmittance that are not bound to the above described limitations of processing and polymer characteristics, wherein the polymer is a polyamide or a polyolefin.

This objective is achieved according to the invention by the presence of a compound B in the molded article wherein the mass of compound B is from 0.25 to 10 mass % relative to the mass of polymer A, and wherein the compound B has a refractive index (n_{B}) higher than the isotropic refractive index of the polymer A (n_{A}).

A stretch molded article according to the above provides an improved transmittance as compared to a comparable molded article without the presence of the compound B in the identified range.

Although additives such as light stabilizers and antioxidants are used in polymers, these additives are effective and added in small quantities (for example <0.1 mass %) to reduce cost and are added in order to improve and preserve properties of the molded articles. Surprisingly, the inventors identified that a specific group of additives and added in a substantially higher amount improve optical properties like transmittance in the visible wavelength range while preserving the excellent mechanical properties of oriented polymer articles.

In the context of the present invention stretched molded articles may have a multitude of shapes in particular stretched molded articles may be fibres, monofilaments, multifilament yarns, staple fibre yarns, tapes, strips and films. The molded article preferably is a fibre, a tape or a film.

Molded articles of the invention comprise a polymer A wherein the polymer A in the molded article is at least partially oriented. By at least partially oriented is understood that the polymer chains show a preferred orientation of the polymer chains in at least one direction, i.e. in the direction of drawing. Such articles comprising a drawn polymer may be produced by drawing, preferably in the solid state, precursor articles by an uniaxial drawing if unidirectional oriented articles are to be produced or by a biaxial drawing if bidirectional oriented articles are to be produced. Such articles with at least partially oriented polymer will exhibit anisotropic mechanical properties. In a preferred embodiment of the invention, the molded article is a monoaxial oriented fibre, a monoaxial oriented tape or film or a biaxial oriented tape or film. Hereby is understood that the polymer chains of polymer A are monoaxially or respectively biaxially oriented, in other words that the polymer chains show one or two preferred directions of orientation.

The polymer A, being a polyamide or a polyolefin, of the molded articles of the invention comprises a crystalline phase and a non-crystalline phase and is hence at least partially crystalline. Preferably the polymer A in the stretch molded article is semi-crystalline, more preferably highly crystalline. In the context of the present application semi-crystalline refers to a degree of structural order in the polymer A in that between 25 and 50 mass % of the polymer A is part of a crystal structure whereby highly crystalline refers to a degree of structural order in the polymer A of more than 50 mass % of the polymer A present in a crystal structure. A convenient way to determine the level of crystallinity of polymer A phase in the molded article is to determine its heat of fusion, also called fusion enthalpy, of the polymer A in the molded article. Accordingly is a preferred embodiment of the present invention that the polymer A in the stretched molded article of the invention has a heat of fusion of at least 50 J/g, preferably 100 J/g more preferably 150 J/g as measured by DSC (ASTM E793). Especially for polyethylene comprising molded articles the heat of fusion permits to calculate a percentage of crystallinity according to ASTM 2625-07. With increased crystallinity, i.e. increased heat of fusion, the mechanical properties of the article could be further improved. The inventors surprisingly found that according to the invention the increased crystallinity may not affect transmittance of the molded article while the mechanical properties such as tensile strength would be improved.

The level of orientation of the polymer chains in the polymer A may be determined by X-ray diffraction measurements further described in the Methods. In the context of the present invention oriented or highly oriented polymer is defined as that the polymer chains run substantially parallel to each other, in case of a monoaxial stretched product this direction is the direction of stretching. The degree of orientation (f_{c}) is defined and measured according to the way described in the METHODS. In a preferred embodiment the stretch molded article of the invention has a degree of orientation (f_{c}) as derived from wide angle X-ray scattering (WAXS) of the polymer A in the stretch molded article of at least 0.6, preferably at least 0.7, more preferably at least 0.8 and most preferably at least 0.9. Stretch molded articles comprising highly oriented polymer A showed amongst others improved tensile strength while transmittance remained high. In a preferred embodiment the molded article has a tensile strength of at least 0.3 GPa, more preferably at least 0.5 GPa, even more preferably at least 0.8 GPa, in at least on direction of the stretch molded article, preferably the drawing direction. In a preferred embodiment the polymer A is an uniaxial oriented polyethylene, preferably uniaxial oriented high density polyethylene, most preferably uniaxial oriented ultra-high molecular weight polyethylene, whereby the stretch molded article preferably has a tensile strength of at least 1.2 GPa and a tensile modulus of at least 40 GPa in the direction of orientation.

In the context of the present invention, refractive index is a dimensionless number expressing the ratio of the speed of light traveling through vacuum to the speed of light travelling through the polymeric material. Refractive index of polymers are for example reported in the Polymer Data Handbook, Oxford University Press, 1999.

Beside alternative measurement methods for the refractive index of a polymeric sample it was found in the context of the present invention that the refractive index of polymer A is conveniently measured by identifying the critical angle (Os) and applying Snell's law, as described in R. K. Krishnaswamy, Polymer Testing, 24 (2005) 762-765. It was found that the therein described method is also suitable for not fully transparent polymeric samples, such as may be the case for the isotropic compression molded sheets of polymer A herein disclosed and reported as n_{A}. Typically the isotropic refractive index n_{A} of the polymer A employed to produce the inventive molded articles is in the range between 1.2 and 2.5, more preferably in the range of 1.3 to 2.0, most preferably in the range of 1.4 to 1.7. Preferably the isotropic refractive index of polymer A is at least 1.3, more preferably at least 1.4 even more preferably at least 1.42 and most preferably at least 1.45.

It should be noted that oriented or highly oriented polymer A as present in the stretch molded article according to the invention may have a refractive index different from n_{A}. Oriented polymer A may even have more than one refractive index. Such refractive index would not be the isotropic refractive index n_{A}, especially in view of the anisotropic nature of oriented polymer A. The refractive index n_{A} of the polymer A of an oriented sample can be measured after removal of the orientation for example by heat treatment, followed by the measurement as described in the Methods.

The polymer A in the inventive article is at least partially oriented and comprises a crystalline and a non-crystalline phase. The polymer A is a polyolefin or a polyamide.

Suitable polyamides are, for example, the aliphatic polyamides PA-6, PA-6,6, PA-9, PA-11, PA-4,6, PA-4,10 and copolyamides thereof, semi-aromatic polyamides based on for example PA-6 or PA-6,6 and aromatic dicarboxylic acids and aliphatic diamines, for example isophthalic acid and terephthalic acid and hexanediamine, for example PA-4T, PA-6/6,T, PA-6,6/6,T, PA-6,6/6/6,T and PA-6,616,116,T. Preferably PA-6, PA-6,6 and PA-4,6 are chosen or aromatic polyamides, for example meta aramide and para aramide. Furthermore, also polyamide blends are suitable.

Preferably the molded article of the present invention comprises a polymer A being a polyolefin, more preferably polyethylene or polypropylene, and most preferably a polyethylene. The inventors identified that the improvement of transmittance of the molded article is remarkably high when the polymer A is a polyethylene. The stretch molded article is not specifically limited to the type of polyethylene present but may be selected from the list consisting of linear low density polyethylene (LLDPE), low density polyethylene (LDPE), high density polyethylene (HDPE), high molecular weight polyethylene (HMWPE), ultra-high molecular weight polyethylene (UHMWPE) or any combination thereof, preferably the PE is HDPE, HMWPE, UHMWPE or any combination thereof. The inventors observed that for HDPE, HMWPE and UHMWPE the increase of transmittance of the stretch molded article is more pronounced.

In a yet preferred embodiment of the invention the polyethylene present in the stretch molded article has a density of at least 0.92 g/cm³, preferably of at least 0.93 g/cm³, more preferably of at least 0.94 g/cm³, even more preferably of at least 0.95 g/cm³ and most preferably of at least 0.96 g/cm³. The skilled person will be aware that with increasing crystallinity of the polyethylene, the density will also increase. Without being bound to any limitations, polyethylene with highest crystallinity have densities of about 0.97 g/cm³ whereas mainly amorphous polyethylenes have densities of 0.90 g/cm³ or below. Again, the inventors found out that the increase in transmittance of stretch molded articles of the present invention are even more pronounced if applied to articles comprising polyethylene of increased density.

A particularly preferred embodiment of the invention are stretch molded articles whereby the polymer A comprises or consists of ultra high molecular weight polyethylene or of polyaramides. Ballistic resistant articles with improved transmittance may be obtained.

In the context of the present invention the ultra high molecular weight polyethylene may be linear or branched, whereby linear polyethylene is preferred. Linear polyethylene is herein understood to mean polyethylene with less than 1 side chain per 100 carbon atoms, and preferably with less than 1 side chain per 300 carbon atoms; a side chain or branch generally containing at least 10 carbon atoms. Side chains may suitably be measured by FTIR. The linear polyethylene may further contain up to 5 mol % of one or more other alkenes that are copolymerisable therewith, such as propene, 1-butene, 1-pentene, 4-methylpentene, 1-hexene and/or 1-octene.

In a preferred embodiment, the polyethylene is of high molar mass with an intrinsic viscosity (IV, as determined on solutions in decalin at 135° C.) of at least 1 dl/g; more preferably of at least 4 dl/g, most preferably of at least 8 dl/g. Such polyethylene with IV exceeding 4 dl/g are also referred to as ultra high molecular weight polyethylene (UHMWPE). Intrinsic viscosity is a measure for molecular weight that can more easily be determined than actual molar mass parameters like Mn and Mw.

The molded article according to the invention further comprises a compound B having a refractive index (n_{B}). compound B may be a mixture of individual components with individual refractive indices, the refractive index of compound B is then considered to be the weight averaged refractive index of components present in the compound B. According to the present invention, n_{B} is higher than n_{A}. Preferably n_{B} is at least 0.01 larger than n_{A}, preferably at least 0.02, more preferably at least 0.04, more preferably at least 0.06 and most preferably at least 0.1 larger than n_{A}. For n_{B} values substantially increasing over n_{A} values, it was observed that the transmittance of the molded article could be improved while respectively low amounts of the compound B needed to be present in the stretch molded article. Although not specifically limited, the difference of refractive index may be constrained by the availability of compounds B with sufficiently high refractive index. Currently only limited number of compounds B are known with a refractive index higher than 2.5. Accordingly a refractive index n_{B} of at most 2.5 may represent an upper limit of refractive index of compound B. Typical examples for materials suitable to improve transmittance of polyethylene stretch molded articles are oligostyrene, cinnamon oil, Tinuvin 328.

In an alternative embodiment of the invention the refractive index of compound B (n_{B}) is at least equal to the refractive index (n′_{A}) of the stretch molded article of the invention, whereby (n′_{A}) is the average of the refractive indices measured parallel and perpendicular to the stretch direction of the molded article. Preferably the n_{B} is at least 0.01 larger than n′_{A}, preferably at least 0.02, more preferably at least 0.03, more preferably at least 0.04 and most preferably at least 0.05 larger than n′_{A}.

The amount of compound B present in the molded article of the present invention is from 0.25 to 10 mass % wherein the mass % is the mass of compound B relative to the mass of polymer A, expressed in %. Preferably, said amount of compound B is at least 0.3 mass %, more preferably at least 0.4 mass %, even more preferably at least 0.5 mass %.

In a yet preferred embodiment, the mass of compound B relative to the mass of polymer A is from 0.3 to 8 mass %, preferably from 0.5 to 5 mass %. The inventors identified that the beneficial effect of compound B to the molded article become limited at values below 0.25 mass % whereas amounts of more than 10 mass % may result in unwanted secondary effects such as deterioration of other properties of the molded article like tensile strength or bleeding of the compound B from the stretched molded article. It was further observed that the relation between the amount of compound B and improved transmittance of the stretch molded article may present an optimum. The skilled person will be able to identify said optimum by optimizing the amounts of compound B versus the stretch ratio applied to the molded article.

Compound B is not specifically limited to other characteristics like organic or inorganic nature of the material, to its physical state under ambient conditions (20° C., 1 bar) or other physical or chemical properties as long as the molded article of the invention can be manufactured and that its physical and chemical properties do not substantially suffer from the presence of compound B. Especially compound B should not negatively affect transparency of the molded article of the invention, which could be the effect of highly colored or black compounds B.

In a preferred embodiment compound B is a fluid in respect to polymer A. Fluid in respect to polymer A in the context of the present invention means that the compound B has a melting temperature (Tₘ) and/or a glass transition temperature (T_{g}), whichever is higher, lower than the melting temperature of the polymer A. Preferably the difference between the melting temperature or the glass transition temperature of compound B, whichever is higher, and the melting temperature of polymer A is at least 10° C., preferably at least 20° C., more preferably at least 40° C. and most preferably at least 60° C. Preferably the melting temperature or the glass transition temperature of compound B is less than 200° C., more preferably less than 140° C., even more preferably less than 100° C. and most preferably less than 60° C.

In an alternative embodiment the compound B is a fluid in respect of the processing conditions of the stretched molded article whereby the melting temperature or the glass transition temperature of compound B, whichever is higher, is at least 10° C., preferably at least 20° C., more preferably at least 40° C. and most preferably at least 60° C. lower than the highest temperature to which the polymer A is exposed during the drawing process of the stretched molded article. The inventors identified that fluid compounds B provide molded articles with further improved transparencies. A further advantage of fluid compounds B is that the compound B can effectively be processed into the molded article since the compound B is molten or at least plasticized under employed process conditions.

Preferably, compound B of the present invention has a molecular weight (MW) of at most 10000 g/mol, preferably at most 5000 g/mol, more preferably at most 2000 g/mol and most preferably at most 1000 g/mol. Where the compound B is a polymer, an oligomer or other mixture of components above molecular weights (MW) are understood to be weight average molecular weights (Mw). At higher molecular weights the processability of the compound B and the molded article's affinity to compound B may be too low. Compounds B having a MW below 100 g/mol are readily dispersed through the molded article but may show high mobility through the molded article and may be removed from the molded article relatively easily by evaporation or bleeding. The molecular weight of the compound B is at least 100 g/mol, preferably at least 200 g/mol.

In an alternative embodiment, compound B is a solid. In the context of the present application a solid compound B has a melting temperature (Tₘ) and/or a glass transition temperature (T_{g}), whichever is higher, higher than the melting temperature of the polymer A. Preferably the difference between the melting temperature or the glass transition temperature of compound B, whichever is higher, and the melting temperature of polymer A is at least 1° C., preferably at least 10° C., more preferably at least 50° C. and most preferably at least 100° C. Typical solid compounds B are high melting polymeric materials or inorganic materials amongst which glasses, ceramics or inorganic salts. In particular inorganic material refers to materials comprising metals, metal oxides, clay, silica, silicates or mixtures thereof but also include carbides, carbonates, cyanides, as well as the allotropes of carbon such as diamond, graphite, graphene, fullerene and carbon nanotubes. The particle size and particle size distribution of the solid compound B are all important parameters in optimizing transmittance of the molded article while preserving processability and mechanical properties of the stretch molded article. A particulate form of the solid compound B may be used, with a powder form being generally suitable. For particles of substantially spherical or cubical shape, the average particle size is substantially equal to the average particle diameter. For particles of substantially oblong shape, such as platelets, needles or fibers, the particle size refers to the length dimension, along the long axis of the particle. Selection of an appropriate particle size and diameter depends on the processing and on the molded article dimensions. In case of molded articles produced by a spinning process, the particles should be small enough to easily pass through the spinneret apertures. The particle size may be selected small enough to avoid appreciable deterioration of the mechanical properties of the molded article. The particle size and diameter may have a log normal distributions.

In a preferred embodiment, the average particle size of the solid compound B is at most 25 micrometer (μm), preferably at most 10 μm, more preferably at most 1 μm, even more preferably at most 0.1 μm and most preferably at most 0.05 μm. Solid compounds B with lower diameter may result in more homogeneous molded articles and may lead to more efficient improvement of the transmittance of the molded article.

As will be shown with the examples further below, a particular advantage of the stretch molded articles comprising the specified compound B according to the invention is that it has improved transmittance as compared to stretch molded articles lacking the presence of compound B. Hence a further preferred embodiment of the invention relates to a molded article according to the invention wherein the article has a transmittance of at least 70%, preferably at least 80% and most preferably at least 90% at a film thickness of 0.1 mm and at a wavelength of 550 nm.

Furthermore the present invention also relates to the use of a compound B with a refractive index n_{B} as a clarifying agent for a stretch molded article comprising at least partially oriented polymer A with an isotropic refractive index n_{A}, wherein n_{B} is larger than n_{A}. Preferably n_{B} is at least 0.01 larger than n_{A}, preferably at least 0.02, more preferably at least 0.05 and most preferably at least 0.1 larger than n_{A}, wherein polymer A is a polyamide or a polyolefin.

The inventors identified that the compound B in the molded article may be present in different phases of the molded article, amongst other in the crystalline and the non-crystalline phases of polymer A. Without being bound to any theory, the inventors are of the opinion that the presence of compound B within the non-crystalline phase of polymer A is preferred over its presence in other portions of the molded article. The inventors observed that when present in the amorphous phase of polymer A compound B may show the strongest effect on transmittance improvement whereas the effect of compound B present within the crystalline phase or outside the polymer A is less pronounced. Accordingly is a preferred embodiment of the present invention a molded article wherein part of the compound B is present in the non-crystalline phase of the polymer A, preferably at least 50% of the compound B present in the molded article is present in the non-crystalline phase of the polymer A, wherein the percentage is expressed as the mass of compound B present in the non-crystalline to the total mass of compound B in the stretch molded article.

The present invention also relates to a process for the production of a stretch molded article according to the invention comprising the steps of
a) providing a polymer A and a compound B wherein the mass of compound B relative to the mass of polymer A is from 0.25 to 10 mass % and wherein the compound B has a refractive index (n_{B}) higher than the isotropic refractive index of polymer A (n_{A}), wherein polymer A is a polyamide or a polyolefin,
b) molding the polymer A and the compound B into a molded article,
c) solid state stretching the molded article in at least one drawing step in at least one direction by a total draw ratio of at least 1.5. Preferably the total solid state draw ratio in said process or in the stretched molded article is at least one direction is at least 2, more preferably at least 3, even more preferably at least 5, most preferably of at least 8.

For said inventive process, the polymer A and the compound B may be selected according to the earlier mentioned embodiments and preferred embodiments. Depending upon the molding process and the stretch molded article to be obtained, in step a) polymer A and compound B may be blended with further products. Polymer A and compound B may amongst others be provided individually, as master batch, dry-blend, premixed or pre-dissolved. The skilled person will be aware of the available dosing equipment and option based on the physical state and amounts to be provided to the process molding.

By molding in the context of the present invention is understood that the polymer A and compound B are brought into a shape via a molding step. Such molding step may for example be compression molding, extrusion molding, cast molding, solution cast molding, injection molding. The molding step under b) may be performed under various conditions of the polymer A, for example in the melt, in solution, as a slurry, as a gel, in solid state or may undergo during the molding process combinations thereof.

Before, during or after the molding process, one or more optional, intermediate process steps may be applied. Such optional process steps may be but are not limited to cooling, quenching, annealing, drying, solvent removal, drawing in the non-solid state, e.g. in gel or melt state, before being subjected to the solid state stretching step c). Said solid state stretching step applied to the molded article comprising polymer A and compound B will provide or further increase the level of orientation and amount of crystalline phase of polymer A. In this context, solid state stretching is understood to apply an elongational deformation to the polymer A resulting in an elongation of the molded article and an increase of orientation of the polymer A while the molded article is kept at a temperature below the melting temperature of polymer A under the stretching conditions. The inventors identified that the combination of solid state draw ratio applied to of the molded article and the nature and amount of compound B provide a more or less broad window of operation to optimize the optical properties of the drawn molded article. Considering the herein provided preferences, the skilled person will be able to optimize the production process together with the nature of polymer A and the nature of compound B to provide stretch molded articles with transmittance and other physical properties that meet the requirements of the field where the stretch molded article is intended to be applied.

By draw ratio in the context of the present invention is understood the ratio between the cross-sectional area of the stretch molded article before drawing to the cross-sectional area of the article after drawing, wherein cross-sectional areas are the surface of respective cross sections of the drawn article perpendicular to at least one drawing direction of the drawn article. Accordingly is a draw ratio of 1 representative for a process without an actual reduction of the cross-sectional area of the article, while a draw ratio of 2 expresses a halving of the cross-sectional area of the article.

A preferred method for the production of the articles of the invention comprises feeding a polymeric powder and compound B between a combination of endless belts, compression-molding the polymeric powder at a temperature below the melting point thereof and rolling the resultant compression-molded polymer followed by solid state drawing. Such a method is for instance described in U.S. Pat. No. 5,091,133, which is incorporated herein by reference. If desired, prior to feeding and compression-molding the polymer powder, the polymer powder may be mixed with a suitable liquid compound having a boiling point higher than the melting point of said polymer. Compression molding may also be carried out by temporarily retaining the polymer powder between the endless belts while conveying them. This may for instance be done by providing pressing platens and/or rollers in connection with the endless belts.

Another preferred method for the production of the articles of the invention comprises feeding a polymer to an extruder, extruding a molded article at a temperature above the melting point thereof and drawing the extruded polymer article below its melting temperature. If desired, prior to feeding the polymer to the extruder, the polymer may be mixed with a suitable liquid compound, for instance to form a gel, such as is preferably the case when using ultra high molecular weight polyethylene.

In yet another preferred method the molded articles of the invention are prepared by a gel process. A suitable gel spinning process is described in for example GB-A-2042414, GB-A-2051667, EP 0205960 A and WO 01/73173 A1, and in “Advanced Fibre Spinning Technology”, Ed. T. Nakajima, Woodhead Publ. Ltd (1994), ISBN 185573 182 7. In short, the gel spinning process comprises preparing a solution of a polymer of high intrinsic viscosity, extruding the solution into a molded article at a temperature above the dissolving temperature, cooling down the article below the gelling temperature, thereby at least partly gelling the article, and drawing the article before, during and/or after at least partial removal of the solvent.

In the described methods to prepare stretch molded articles, the drawing, preferably uniaxial drawing, of the produced articles may be carried out by means known in the art. Such means comprise extrusion stretching and tensile stretching on suitable drawing units. To attain increased mechanical tensile strength and stiffness, drawing may be carried out in multiple steps.

In case of the preferred ultra high molecular weight polyethylene products, drawing is typically carried out uniaxially in a number of drawing steps. The first drawing step may for instance comprise drawing to a stretch factor (also called draw ratio) of at least 1.5, preferably at least 3.0. Multiple drawing may typically result in a stretch factor of about 9 for drawing temperatures up to 120° C., a stretch factor of about 25 for drawing temperatures up to 140° C., and a stretch factor of 50 for drawing temperatures up to and above 150° C. By multiple drawing at increasing temperatures, stretch factors of about 50 and more may be reached. This results in high strength molded articles, whereby for ultra high molecular weight polyethylene, tensile strengths of 1.5 GPa to 1.8 GPa and more may be obtained.

Methods to biaxial draw molded articles are as well broadly known to the skilled person and can be combined or integrated in above described methods. Amongst others a biaxial drawing method is blow molding of melt or gel extruded tubes or a biaxial sheet stretching as for example disclosed in EP0378279 which is herewith incorporated by reference.

The present invention provides solid state drawn articles with increased transmittance. Preferably such article is a monoaxial oriented fibre, a monoaxial oriented tape or film or a biaxial oriented tape or film. Such articles with increased transmittance may be broadly applied in the fields of technology where both transmittance and properties inherent to drawn molded articles are known. Typical fields of application would be high strength packaging films, transparent antiballistic armor but also glass and acrylic glass replacement. Therefor the present application also relates to an article comprising a drawn molded article according to the invention, preferably the article is a ballistic resistant article, a visor, a car part, a windshield, a window, a radome.

### Methods

Transparency/Haze/Transmittance
Transmittance spectra were measured in the range of 250-800 nm on a Shimadzu (Japan) UV-3102 PC spectrophotometer with a 1-nm interval, equipped with a MPC-3100 multi-purpose large sample compartment at 50% humidity and 23° C. The distance between samples and the detector is 30 mm Blank measurement was performed, without a sample and the transmitted light to the detector at each wavelength was set to 100%. The recorded light transmission at each wavelength was normalized to the blank measurement and the transmittance value was obtained.

### Tensile Strength

The Young's modulus and tensile strength of the drawn samples was measured at room temperature on a Zwick Z100 tensile tester at a crosshead speed of 10 and 100 mm/min, respectively. The Young's moduli were calculated from the tangents of the stress-strain curves at a strain of 0.05-0.1%. In all cases, at least three strips were measured and the mean values of Young's modulus together with tensile strength and the corresponding standard deviation were calculated and reported. For calculation of the tensile strength, the tensile forces measured are divided by the cross-sectional area, as determined by weighing 1 centimeter of molded drawn tapes; values in GPa are calculated with the density of the molded article measured according to the method below.
The Herman's orientation function (f_{c}) was determined with wide angle X-ray diffraction (WAXS) performed on a Ganesha lab instrument equipped with a Genix-Cu ultra-low divergence source producing X-ray photons with a wavelength of 1.54 Å and a flux of 1×10⁸ photons/sec. Diffraction patterns are collected on a Pilatus 300K silicon pixel detector placed at a sample detector distance of 180 mm. Azimuthal integration of the obtained diffraction patterns is performed to obtain the intensity versus the scattering vector. The Herman's orientation function of the drawn PE obtained from the azimuthal intensity distribution along the scattering circles. Traditionally, the orientation (f_{c}) is defined by: f_{c}=(3<cos²φ>−1)/2, where φ is the angle between the stretching direction and the long axis of each molecule, the brackets denote an average over all of the molecules in the sample. The degree of crystallinity (X_{cw}) is calculated from the wide angle X-ray diffraction (WAXS) using the following equation:

$$Xcw = \frac{{I}_{110} + 1 , 46 {I}_{200}}{{I}_{110} + 1 , 46 {I}_{200} + 0.75 {I}_{a}} \cdot 100 \%$$

where I₁₁₀, I₂₀₀, and Iₐ are the integral areas of the (110), (200) and the amorphous peak of polyethylene, respectively.
The heat of fusion (ΔH_{F}) was established by differential scanning calorimetry according to ASTM E 793-85 in the interval from room temperature to 200° C. at a heating rate of 5° C./min. For Polyethylene samples a crystallinity (X_{cd}) was calculated from the equation: X_{cd}=ΔH_{F}/ΔH_{F}⁰, where ΔH_{F}⁰ is the heat of fusion of perfect crystalline HDPE which is assumed to be equal to 280 J/cm³.
Density of the molded article was determined according to ISO 1183 method A

Intrinsic Viscosity (IV)
IV is determined according to ASTM-D1601/2004 at 135° C. in decalin, the dissolution time being 4 hours, with DBPC as anti-oxidant in an amount of 2 g/l solution, by extrapolating the viscosity as measured at different concentrations to zero concentration.

Refractive Index
Refractive Index (n) of polymeric samples as reported herein are measured on isotropic compression molded samples with a thickness of about 0.5 mm. The measurement has be performed according to the method reported in R. K. Krishnaswamy, Polymer Testing, 24 (2005) 762-765 on a Metricon Prism Coupler and by averaging refractive indices along two perpendicular directions of the sample to account for potential molecular orientation effects at a wavelength of 633 nanometers and at 293K under atmospheric pressure.
Refractive Index (n′) of polymeric samples as reported herein are measured on oriented stretch molded samples with a thickness of about 0.1 mm. The measurement has be performed according to the method reported in R. K. Krishnaswamy, Polymer Testing, 24 (2005) 762-765 on a Metricon Prism Coupler and by averaging refractive indices along two perpendicular directions of the sample to account for potential molecular orientation effects at a wavelength of 633 nanometers and at 293K under atmospheric pressure.
Methods to measure refractive indices of non-polymeric samples are readily available and have been retrieved from product data sheets and can be confirmed by refractometry under ambient conditions at a wavelength of 589 nm (Sodium D-line, NaD).

Materials

The used high density polyethylene (HDPE) was purchased from Borealis, grade

VS4580 (Burghausen, Germany) with a number- and weight-average molecular weight of approximately 3.7×10⁴ and 1.3×10⁵ g/mol respectively.

BZT (2-(2H-benzotriazol-2-yl)-4, 6-ditertpentylphenol; Tinuvin 328) was purchased from BASF (Germany).

Cinnamon oil (CO) and Oligostyrene oil (OS) (average MW: 800 g/mol) were obtained from Sigma-Aldrich Co. (Germany) and used without further purification.

Paraffin oil (PO) was purchased from Thermo Fisher Scientific Inc. (Netherland). 3M™ Dynamar™ Polymer Processing Additive FX 5911 was purchased from 3M (Germany).

### EXPERIMENTAL

HDPE samples containing between 0.5 and 5 mass % of a compound B were prepared by blending the respective amounts in a co-rotating twin screw extruder at 160° C. The extrudates were cooled in a water bath at room temperature, air dried and pelletized into granules. Subsequently, isotropic sheets of approximately 1.0 mm thickness were produced by compression moulding at 160° C. Dumbbell-like samples with gauge dimensions 1.2×0.2 cm were then cut from the compression-moulded sheets. These dumbbell-like samples were subsequently drawn to various draw ratios at 80° C. in air using a Zwick Z100 tensile tester at a crosshead speed of 100 mm/min. The thickness of the drawn samples was calculated by weighing, assuming a density equal to 0.96 g/cm³. Refractive index of the isotropic sheets comprising 0-5 mass % of compound B were 1.50+/−0.01 whereas the therefrom drawn samples had refractive indices of 1.54+/−0.01.

Young's modulus, strength and transmittance of the tapes after uniaxial drawing were measured and are reported in Table 1. It is observed that the mechanical properties are maintained upon addition of the additive.

Furthermore can the influence of the solid state DR and the content of compound B on the transmittance of the films be observed in table 1. It is found that the transmittance as a function of DR exhibits a maximum and that its absolute value increases with increasing additive content. A high transmittance was achieved at draw ratios of 10 to 20 which correspond to maximum Young's modulus and strength of ˜20 GPa and ˜0.65 GPa, respectively.

TABLE 1

| | | B | | | | | | | | | |
|---|---|---|---|---|---|---|---|---|---|---|---|
| | | [mass | n_{B} | | HoF | X_{cw} | X_{cd} | Modulus | Strength | Thickn. | Transm. |
| | Comp. B | %] | — | DR | [J/g] | [%] | [%] | [GPa] | [GPa] | [μm] | @550 nm [%] |
| Comp. A | BZT | 1 | 1.575 | 1 | 170.2 | 65.5 | 60.7 | 0.5 | 0.044 | 500 | — |
| Example 1 | BZT | 1 | 1.575 | 15 | 198.8 | 68.8 | 71.0 | 11.6 | 0.431 | 120 | 81 |
| Comp. B | BZT | 2 | 1.575 | 1 | 168.0 | 62.9 | 60.0 | 0.3 | 0.046 | 500 | — |
| Example 2 | BZT | 2 | 1.575 | 10 | | 62.3 | | 8.1 | 0.370 | 160 | 90 |
| Example 3 | BZT | 2 | 1.575 | 15 | 197.8 | 66.4 | 70.6 | 12.6 | 0.469 | 120 | 90 |
| Example 4 | BZT | 2 | 1.575 | 20 | | 67.5 | | 18.2 | 0.643 | 100 | 89 |
| Example 5 | BZT | 5 | 1.575 | 20 | | | | | | 100 | 90 |
| Example 6 | CO | 2 | 1.533 | 10 | | | | | | 160 | 87 |
| Example 7 | OS | 2 | 1.576 | 10 | | | | | | 160 | 88 |
| Comp. C | — | — | — | 1 | 166.4 | 65.3 | 59.3 | 0.4 | 0.048 | 500 | — |
| Comp. D | — | — | — | 10 | | 65.1 | | 6.9 | 0.343 | 160 | 50 |
| Comp. E | — | — | — | 15 | 205.2 | 68.9 | 73.3 | 12.5 | 0.447 | 120 | 53 |
| Comp. F | — | — | — | 20 | | 71.4 | | 18.9 | 0.657 | 100 | 46 |
| Comp. G | PO | 2 | 1.473 | 10 | | | | | | 160 | 53 |
| Comp. H | FX-5911 | 2 | 1.36 | 10 | | | | | | 160 | 39 |

It is well-known that the drawn films might suffer from surface light scattering, thus resulting in a loss of transmittance. In an additional measurement a few drops of paraffin oil were coated on the surface of the drawn HDPE films of example 2, 4 and comparative B. The films were subsequently sandwiched between two glass slides. A further slight improvement of transmittance in the range of 2 and 4% in optical transmittance upon coating with a low viscous fluid is observed. Highly transparent drawn HDPE films with a truly glass-like appearance (transmittance >90%) could be obtained.

1. A stretched molded article comprising a polymer A and a compound B, wherein the polymer A is a polyamide or a polyolefin and is at least partially oriented and comprises a crystalline phase and a non-crystalline phase, wherein the mass of compound B is from 0.25 to 10 mass % relative to the mass of polymer A, and wherein the compound B has a refractive index (n_{B}) higher than the isotropic refractive index of polymer A (n_{A}).

2. Molded article according to claim 1 wherein n_{B} is at least 0.01 larger than n_{A}, preferably at least 0.02, more preferably at least 0.05 and most preferably at least 0.1 larger than n_{A}.

3. Molded article according to claim 1 wherein the mass of compound B relative to the mass of polymer A is from 0.3 to 8 mass %, preferably from 0.5 to 5 mass %.

4. Molded article according to claim 1, wherein the molded article is a fibre, a tape or a film.

5. Molded article according to claim 1 wherein the at least partially oriented polymer A is semi-crystalline, preferably highly crystalline, preferably the partly oriented polymer A has a heat of fusion of at least 50 J/g, preferably at least 100 J/g, most preferably at least 150 J/g, whereby the heat of fusion is determined by Differential Scanning calorimetry according to ASTM E 793-85.

6. Molded article according to claim 1 wherein the polymer A has a degree of orientation as derived from wide angle X-ray scattering (WAXS) of at least 0.6, preferably 0.7 most preferably at least 0.8.

7. Molded article according to claim 1 wherein the polymer A is a polyolefin, most preferably polymer A is polyethylene or polypropylene.

8. Molded article according to claim 7 wherein polyethylene (PE), is a linear low density polyethylene (LLDPE), low density polyethylene (LDPE), high density polyethylene (HDPE), high molecular weight polyethylene (HMWPE), ultra-high molecular weight polyethylene (UHMWPE) or any combination thereof, preferably the PE is HDPE, HMWPE, UHMWPE or any combination thereof, more preferably the PE has a density of at least 0.92 g/cm³, preferably of at least 0.93 g/cm³, more preferably of at least 0.94 g/cm³, even more preferably of at least 0.95 g/cm³ and most preferably of at least 0.96 g/cm³.

9. Molded article according to claim 1 wherein the article has a transmittance of at least 70%, preferably at least 80% and most preferably at least 90% when measured at a film thickness of 0.1 mm and at a wavelength of 550 nm.

10. Molded article according to claim 1 having a tensile strength of at least 0.5 GPa in at least on direction of the molded article.

11. Molded article according to claim 1 wherein part of the compound B is present in the non-crystalline phase of the polymer A, preferably at least 50 mass % of the compound B present in the molded article is present in the non-crystalline phase of polymer A.

12. Molded article according to claim 1 wherein the article is a monoaxial oriented fibre, a monoaxial oriented tape or film or a biaxial oriented tape or film.

13. A process for the production of the stretch molded article according to claim 1 comprising the steps of
a) providing polymer A and compound B wherein the mass of compound B relative to the mass of polymer A is from 0.25 to 10 mass % and wherein the compound B has a refractive index (n_{B}) higher than the isotropic refractive index of the polymer A (n_{A}), wherein the polymer is a polyamide or a polyolefin,
b) molding the polymer A and the compound B into a molded article,
c) solid state stretching the molded article in at least one drawing step in at least one direction by a total draw ratio of at least 1.5, preferably of at least 2, more preferably of at least 3, even more preferably at least 5, most preferably of at least 8.

14. Use of a compound B with a refractive index n_{B} as a clarifying agent for a stretch molded article comprising at least partially oriented polymer A with an isotropic refractive index n_{A}, wherein n_{B} is larger than n_{A}.

15. An article comprising a molded article according to claim 1, preferably the article is a ballistic resistant article, a visor, a car part, a windshield, a window or a radome.
